(19) United States
(12) Patent Application Publication
(10) Pub. No.: US 2012/0272662 A1
(43) Pub. Date: Nov. 1, 2012

(54) HEAD PART OF AN ANNULAR COMBUSTION CHAMBER

(75) Inventor: Richard G. MILBURN, Nottingham (GB)

(73) Assignee: ROLLS-ROYCE PLC, London (GB)

(21) Appl. No.: 13/451,051

(22) Filed: Apr. 19, 2012

(30) Foreign Application Priority Data
Apr. 28, 2011 (GB) 1107093.5

(51) Int. Cl. F23R 3/28; B21D 53/00; F02C 7/20

(52) U.S. Cl. 60/796; 60/740; 29/889.22

(57) ABSTRACT

A head part (100) of an annular combustion chamber for a gas turbine, the head part comprising: an end wall (110) with a first opening (112) for accommodating a burner; a heat shield (120) covering a back side of the end wall which faces towards the combustion chamber, the heat shield comprising a second opening (124) for accommodating the burner; and a burner collar (130) adapted to fit within the second opening and receive the burner; wherein the head part of the annular combustion chamber is configured such that in an installed configuration the burner collar is fastened to the heat shield with one or more first fasteners (142) to form a sub assembly (140) and the heat shield of the sub assembly is fastened to the end wall with one or more second fasteners (144).

### CROSS-REFERENCE TO RELATED APPLICATIONS

This application is based upon and claims the benefit of priority from British Patent Application Number 1107093.5 filed 28 Apr. 2011, the entire contents of which are incorporated by reference.

### BACKGROUND OF THE INVENTION

1. Field of the Invention

The present disclosure relates to a head part of an annular combustion chamber and particularly but not exclusively relates to a head part of an annular combustion chamber for a gas turbine.

2. Description of the Related Art

The operation of gas turbine engines is relatively well known and, as will be appreciated, requires presentation of fuel for combustion in order to generate thrust. In order to present that fuel, a fuel spray nozzle or burner is required. A plurality of burners may be provided about the annulus of an annular combustion chamber.

Referring to FIGS. 1(a) and (b), which show a previously-proposed arrangement, the fuel burner (not shown) is typically located within an end wall or meter panel 10 such that the fuel spray is appropriately presented within the combustor parts of the gas turbine engine. It will be understood that the combustor parts of a gas turbine engine will generate significant heat and therefore thermal stressing as well as vibration and other factors may create significant wear upon the mountings for the spray nozzle. In such circumstances a burner seal or burner collar 30 is generally provided within the end wall 10 which ensures that the fuel spray nozzle is appropriately presented. A heat shield 20 is also provided to protect the end wall 10 from the hot burner gases and from an unacceptably high radiation effect. Furthermore, upon repair and overhaul it is generally easier to replace the heat shield 20 rather than the end wall 10 within the gas turbine engine.

In the previously-proposed arrangement shown in FIG. 1, the burner collars 30 and hence burners are held in place by virtue of a fastening bolt 22, which is fastened to the end wall 10. The heat shield 20 is also fastened to the end wall 10. The bolt 22 secures the burner collar 30 to the end wall 10 and the bolt 22 is tack welded to the end wall 10. The burner collar 30 comprises a flat edge 33 where the bolt 22 secures the burner collar 30 to the end wall 10. The flat edge 33 may engage a washer element 23, which comprises a corresponding flat edge and which is held in place by the bolt 22. The flat edge 33 and washer element 23 ensure that the burner collar 30 may not rotate with respect to the end wall 10.

As shown in FIG. 1(b), the end wall 10 comprises bores 42 for receiving the fastening bolts 22. The end wall 10 also comprises bores 44 for receiving fastening studs 25, which secure the heat shield 20 to the end wall 10.

A location or closure ring 12 is provided between the burner collar 30 and end wall 10. The end wall 10 may be cast and the front side of the end wall (i.e. the side facing away from the combustion chamber) may not be machined smooth. The location ring 12 therefore provides a flat surface for the burner collar 30 to rest on.

Further examples of previously-proposed arrangements are shown in U.S. Pat. No. 5,996,335, EP1975514, U.S. Pat. No. 5,956,955 and U.S. Pat. No. 5,894,732.

With the previously-proposed arrangements, the head components can only be assembled from the cold side of the end wall 10, i.e. the side not facing the combustion chamber. The cold side of the end wall 10 is less convenient to access, because the location ring 12 and burner collar 30 have to be “posted” through a slot (not shown) in the cowl and passed around the space between the cowl and the end wall 10 to the required burner position. Furthermore, due to a lack of space on the cold side of the end wall, the components for each burner position have to be assembled or disassembled in sequence. For example, to remove the tenth burner collar, the first to ninth burner collars have to be removed first. This further complicates the installation process and adds weight to the cowl since the slot requires a cover plate and rivets. Furthermore, additional time is required to assemble and dissemble the components, e.g. on first build or during an overhaul, and this further adds to the costs.

In addition, it takes approximately three hours to provide the tack weld between the burner collar fastener 22 and the end wall 10 for each of the burners. A similar amount of time is required to overhaul, remove or replace the tack welds. When maintaining a fleet of engines, this time incurs a significant cost.

The present disclosure therefore seeks to address these issues.

### OBJECTS AND SUMMARY OF THE INVENTION

According to a first aspect of the present invention there is provided a head part of an annular combustion chamber for a gas turbine, the head part comprising: an end wall with a first opening for accommodating a burner; a heat shield covering a back side of the end wall which faces towards the combustion chamber, the heat shield comprising a second opening for accommodating the burner; and a burner collar adapted to fit within the second opening and receive the burner; wherein the head part of the annular combustion chamber is configured such that in an installed configuration the burner collar is fastened to the heat shield with one or more first fasteners to form a sub assembly and the heat shield of the sub assembly is fastened to the end wall with one or more second fasteners.

The first opening of the end wall may be sized to accommodate the one or more first fasteners. The end wall may comprise one or more further openings to accommodate the one or more second fasteners. The heat shield may be spaced apart from the end wall and the one or more first fasteners may be at least partially accommodated in a gap between the heat shield and end wall.

The sub assembly comprising the heat shield and burner collar may be fastened to the end wall from the combustion chamber side of the end wall.

The burner collar may comprise a protruding portion radially protruding from an outer surface of the burner collar. The protruding portion of the burner collar may extend about the perimeter of the burner collar.

An intermediate member, e.g. ring, may be provided between the burner collar and heat shield. The intermediate member may comprise a smooth surface for the burner collar to rest on. The intermediate member may be a ring with an “L” shaped cross section.

The first fasteners may comprise a threaded rod and nut assembly. For example, the first fasteners may comprise studs.

The first fasteners, second opening and/or burner collar may be configured to permit relative radial movement between the burner collar and the heat shield.

A combustion chamber may comprise the above-mentioned head part of the annular combustion chamber. A gas turbine engine may comprise the above-mentioned head part of the annular combustion chamber.

According to a second aspect of the present invention there is provided a method of installing a burner collar of a head part of an annular combustion chamber for a gas turbine, the head part comprising: an end wall with a first opening for accommodating a burner; a heat shield covering a back side of the end wall which faces towards the combustion chamber, the heat shield comprising a second opening for accommodating the burner; and a burner collar adapted to fit within the second opening and receive a burner; wherein the method comprises: fastening the burner collar to the heat shield with one or more first fasteners to form a sub assembly; and fastening the heat shield of the sub assembly to the end wall with one or more second fasteners.

### BRIEF DESCRIPTION OF THE DRAWINGS

For a better understanding of the present disclosure, and to show more clearly how it may be carried into effect, reference will now be made, by way of example only, to the accompanying drawings, in which:

FIGS. 1(a) and (b) show a previously-proposed head part of an annular gas turbine combustion chamber with FIG. 1(a) showing a perspective view and FIG. 1(b) showing an end on view of an end wall forming part of the head part of the annular gas turbine combustion chamber;

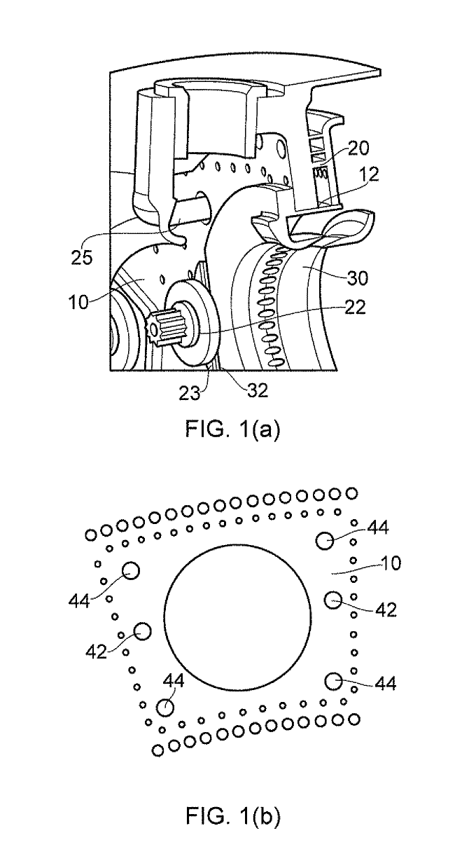

FIGS. 2(a) and (b) show a head part of an annular combustion chamber according to an example of the present disclosure with FIG. 2(a) showing an end on view and FIG. 2(b) showing a sectional view;

FIGS. 3(a) and (b) show two of the constituent parts of the head part of the annular combustion chamber according to the example of the present disclosure with FIG. 3(a) showing a heat shield and FIG. 3(b) showing an end wall; and

FIGS. 4(a) and (b) show cross-sectional views of a further example of the present disclosure with FIG. 4(a) showing a sectional view at the first fastener and FIG. 4(b) showing a sectional view at a location between first fasteners.

### DETAILED DESCRIPTION OF THE PREFERRED EMBODIMENTS

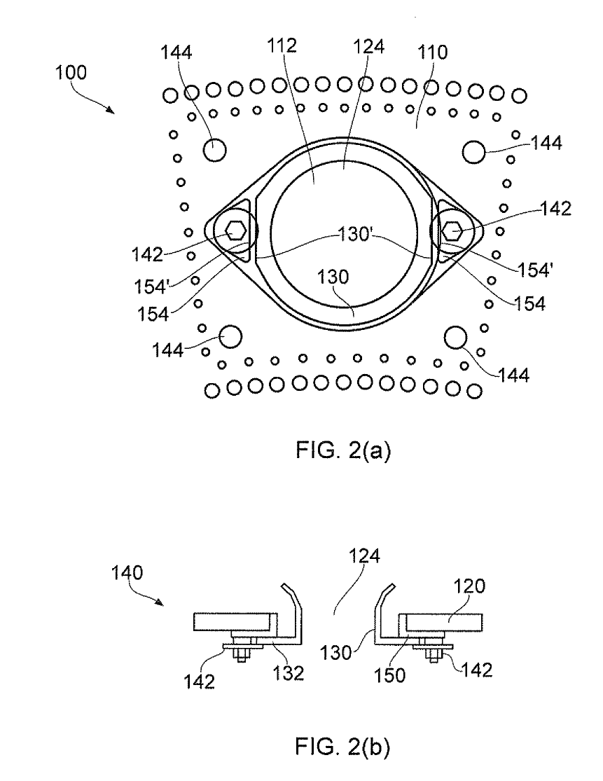

With reference to FIGS. 2(a) and 2(b), a head part 100 of an annular gas turbine combustion chamber, according to a first example of the present disclosure, may comprise an end wall or meter panel 110 which may act as a supporting and/or dividing wall for a combustion chamber downstream of the end wall 110. The end wall 110 may comprise a first opening 112 for accommodating a burner (not shown). The end wall 110 may comprise a substantially annular body disposed about a longitudinal axis of the gas turbine (not shown) and a plurality of burners may be provided equiangularly distributed about the end wall 110. To this extent, this annular combustion chamber corresponds to the known state of the art. Also in a known manner, several burners project in a circularly arranged manner into the annular combustion chamber, by way of which fuel as well as combustion air may be charged in a swirled manner into the combustion chamber.

The head part 100 may also comprise a heat shield 120 covering a back side of the end wall 110 which faces towards the combustion chamber. The heat shield 120 may protect the end wall 110 from the hot burner gases and from an unacceptably high radiation effect. The heat shield 120 may comprise a sector of the annulus such that a plurality of the heat shields 120 together form the annulus. The heat shield 120 may have a second opening 124 for receiving the burner.

The burner (not shown) may be surrounded by a burner seal or burner collar 130, which may ensure that a large portion of the combustion air flows into the combustion chamber by way of the burner. Accordingly, the head part 100 may further comprise the burner collar 130 adapted to fit within the passage opening 112 of the end wall 110 and second opening 124 of the heat shield 120.

The burner collar 130 may comprise a protruding portion 132 radially protruding from an outer surface of the burner collar 130. The protruding portion 132 of the burner collar 130 may extend about the perimeter of the burner collar 130. The protruding portion 132 of the burner collar 130 may define an annular rim.

In an installed configuration the burner collar 130 protruding portion 132 may rest against the front side of the heat shield 120 (i.e. the side facing away from the combustion chamber). An optional intermediate member 150, e.g. ring, may be provided between the burner collar 130 and the heat shield 120. The heat shield 120 may be cast and the front side of the heat shield 120 (i.e. the side facing away from the combustion chamber) may not be machined smooth. The intermediate member 150 may therefore provide a smooth flat surface for the burner collar 130 to rest on. The intermediate member 150 may also provide a wearing surface for the burner collar 130 to rest on. The intermediate member 150 may be a ring with an “L” shaped cross section and may fit inside the second opening 124 of the heat shield 120.

The burner collar 130 may be fastened to the heat shield 120 with one or more first fasteners 142. The burner collar 130 and heat shield 120 may thus form a sub assembly 140. As shown, the burner collar 130 may be fastened to the heat shield 120 with two of the first fasteners 142. The intermediate member 150 may comprise one or more openings for receiving the one or more first fasteners 142. The heat shield 120 of the sub assembly 140 may in turn be fastened to the end wall 110 with one or more second fasteners 144. As shown, the sub assembly 140 may be located from the back side of the end wall 110 and fastened to the end wall 110 by four of the second fasteners 144.

The first and/or second fasteners 142, 144 may comprise a threaded rod and nut assembly. For example, the first fasteners may comprise studs and nuts, e.g. instead of bolts and nuts, although in an alternative embodiment bolts and nuts may be used. The studs may be secured to and extend from the, heat shield. By using studs instead of bolts a twisting force acting on the shaft of the first fasteners may be reduced. This is because a stud is tightened from a relaxed state and the pressure from the nut will make the stud stretch along its longitudinal axis only, e.g. without an additional twisting load. The result is a more evenly distributed and accurate torque load compared to that of a bolt. This ultimately translates into higher reliability and a lower chance of failure. The use of bolts for the first fasteners require thickened bosses on the heat shield, increasing weight, and requiring the bolts to be tack welded to the heat shield. Accordingly, the fasteners of the present disclosure may not require welding to the end wall to prevent any rotation of the fasteners.

A spacer 154 may be provided between the intermediate member 150 and the nut of fastener 142. The spacer 154 may have an opening for the first fastener 142 to pass through. The spacer 154 may be integral with the intermediate member 150 and form a raised portion of the intermediate member 150. The spacer 154 may comprise a flat surface 154′ which may engage a corresponding flat surface 130′ on the burner collar 130. The flat surfaces 154′, 130′ of the spacer 154 and the burner collar 130 may prevent rotation of the burner collar 130 with respect to the heat shield 120. The flat surfaces 154′, 130′ of the spacer 154 and the burner collar 130 may optionally be omitted.

To accommodate build tolerances and thermal growths the heat shield opening 124 and/or burner collar 130 may be configured to permit limited relative radial movement between the burner collar 130 and the heat shield 120. For example, the first fasteners 142 may also be configured to ensure that the burner collar 130 may move with respect to the heat shield 120 in a radial direction but not in a longitudinal direction. Furthermore, the spacing between the first fasteners 142 may be greater than the diameter of the burner collar 130 protruding portion 132 at the location of the first fasteners (i.e. accounting for any burner collar flats 130′). Equally, the diameter of the second opening 124 may be greater than the diameter of the burner collar 130. However, the diameter of the burner collar 130 protruding portion 132 may be sufficiently greater than the diameter of the second opening 112 to ensure that, despite any radial movement, no gap may occur between the heat shield 120 and the burner collar 130.

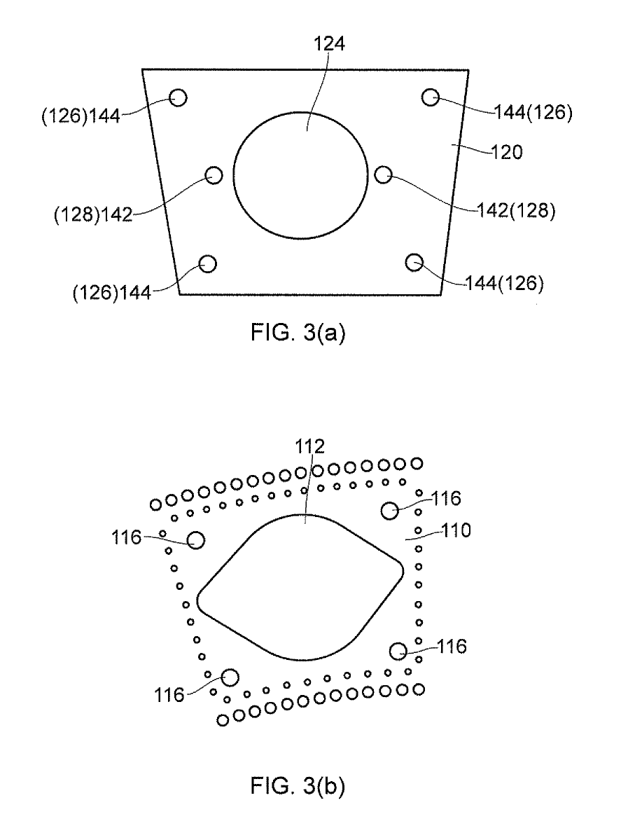

With reference to FIG. 3, two of the component parts of the head part 100 are shown. FIG. 3(a) shows the heat shield 120 whilst FIG. 3(b) shows the end wall 110 of the present disclosure. The heat shield 120 may comprise four studs 144 of the four second fasteners 144 to fasten the heat shield 120 to the end wall 110. The studs 144 may be disposed adjacent to corners of the heat shield 120. Furthermore, the heat shield 120 may further comprise two studs 142 of the two first fasteners 142 to fasten the burner collar 130 to the heat shield 110. The studs 142 may be disposed adjacent to the second opening 124 and may be diametrically opposed to one another. If bolts are used then bores 128, 126 may be provided where studs 142, 144 are positioned and the bores may be threaded, e.g. for receiving a threaded rod, and the bores may extend all the way through the heat shield 120.

As shown in FIG. 3(b), the end wall 110 may comprise four bores 116 corresponding to the heat shield bores 126. The bores 116 are adapted to receive the four second fasteners 144 to fasten the heat shield 120 to the end wall 110. Furthermore, the first opening 112 of the end wall 110 may be larger than the second opening 124 of the heat shield 120 and as such may also be larger than the openings of the prior art. As depicted in FIG. 2(a), the larger first opening 112 may provide enough clearance for the burner collar 130 first fasteners 142. Alternatively, in addition to the first opening 112 the end wall 110 may comprise one or more further openings (not shown) to accommodate the one or more first fasteners 142. Furthermore, the heat shield 120 may be spaced apart from the end wall 110 and the one or more first fasteners 142 may be at least partially accommodated in a gap between the heat shield 120 and end wall 110.

The burner collar 130 may be installed by first joining the burner collar 130 to the heat shield 120 by virtue of the first fasteners 142. The resulting sub assembly 140 may then be inserted from the combustion chamber side of the end wall 110. The heat shield 120 may then be secured to the end wall 110 by virtue of the second fasteners 144.

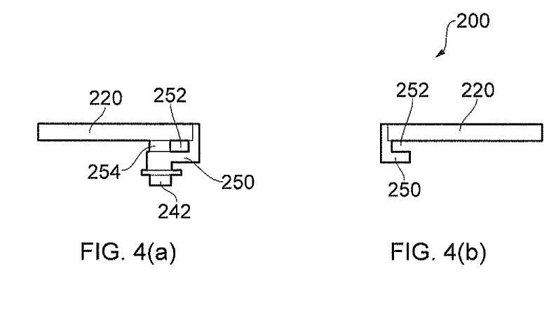

With reference to FIG. 4, a further example of the present disclosure is shown. As already depicted for the previous example, the head part 200 may comprise an intermediate member 250, e.g. ring, disposed between the burner collar (not shown in FIG. 4) and the heat shield 220. As for the previous example, the intermediate member 250 may provide a smooth flat surface for the burner collar to rest on. The intermediate member 250 may additionally be spaced part from the heat shield 220, at least over a portion of the intermediate member 250. However, a portion of the intermediate member 250 may be disposed such that it remains in contact with the front side of the heat shield 220, thereby ensuring that the remainder of the intermediate member 250 is spaced part from the heat shield 220. The resulting gap 252 between the intermediate member 250 and the heat shield 220 may provide a space for cooling air, e.g. for cooling the heat shield 220. Furthermore, the intermediate member 250 being spaced apart from the heat shield 220 may also allow existing burner collars to be used in the heat shield 220 of the present disclosure. For example, the previously-proposed head parts have burner collars which engage the end wall, and by spacing the intermediate member 250 apart from the heat shield 220, the burner collars may adopt the same longitudinal position with respect to the end wall.

FIG. 4(a) shows a sectional view of the intermediate member 250 at the first fastener 242 and, as depicted, a spacer 254 may be provided between the intermediate member 250 and the heat shield 220. The spacer 254 may have an opening for the first fastener 242 to pass through. FIG. 4(b) shows a sectional view at a location spaced apart from the first fastener 242 and, as depicted, there may be no spacer between the intermediate member 250 and the heat shield 220 at such a location.

The present disclosure advantageously reduces the cost and weight of the combustion chamber. The larger opening in the end wall to allow access for the sub assembly provides a significant weight saving. For example, for a typical annular combustion chamber a weight reduction of approximately 702 grams has been estimated, which in the case of a jet engine is a significant saving. Further weight savings are made since the “letter box” slot in the cowl together with the associated cover plate and rivets are no longer required with the present disclosure.

In addition, the component parts of the present disclosure are significantly easier to assemble. For example, the components at each individual burner position can be removed and/or assembled independently of other burner positions, in contrast with the previously-proposed arrangements where they all have to be assembled or dissembled in sequence. Furthermore, it is estimated that elimination of the tack welds to secure the fastening bolts of the prior art would reduce overhaul time by at least three hours. With the present disclosure, the heat shield sub-assembly would be quicker and easier to complete and may be fastened together prior to installation within the combustion chamber. Assembly time and cost are thus reduced not only on construction but also at overhaul.

Furthermore, existing combustion chambers, e.g. in existing engines, may be retrofitted with the head part of the present disclosure.

We claim:

1. A head part of an annular combustion chamber for a gas turbine, the head part comprising:
an end wall with a first opening for accommodating a burner;
a heat shield covering a back side of the end wall which faces towards the combustion chamber, the heat shield comprising a second opening for accommodating the burner; and
a burner collar adapted to fit within the second opening and receive the burner, wherein:
the head part of the annular combustion chamber is configured such that in an installed configuration the burner collar is fastened to the heat shield with one or more first fasteners to form a sub assembly and the heat shield of the sub assembly is fastened to the end wall with one or more second fasteners; and
the first opening of the end wall is sized to accommodate the burner and the one or more first fasteners.

2. The head part of an annular combustion chamber as claimed in claim 1, wherein the end wall comprises one or more further openings to accommodate the one or more second fasteners.

3. The head part of an annular combustion chamber as claimed in claim 1, wherein the heat shield is spaced apart from the end wall and the one or more first fasteners are at least partially accommodated in a gap between the heat shield and end wall.

4. The head part of an annular combustion chamber as claimed in claim 1, wherein the sub assembly comprising the heat shield and burner collar is fastened to the end wall from the combustion chamber side of the end wall.

5. The head part of an annular combustion chamber as claimed in claim 1, wherein the burner collar comprises a protruding portion radially protruding from an outer surface of the burner collar.

6. The head part of an annular combustion chamber as claimed in claim 5, wherein the protruding portion of the burner collar extends about a perimeter of the burner collar.

7. The head part of an annular combustion chamber as claimed in claim 1, wherein an intermediate member is provided between the burner collar and heat shield.

8. The head part of an annular combustion chamber as claimed in claim 7, wherein the intermediate member comprises a smooth surface for the burner collar to rest on.

9. The head part of an annular combustion chamber as claimed in claim 1, wherein the first fasteners comprise a threaded rod and nut assembly.

10. The head part of an annular combustion chamber as claimed in claim 1, wherein the first fasteners, second opening and/or burner collar are configured to permit relative radial movement between the burner collar and the heat shield.

11. A combustion chamber comprising the head part of the annular combustion chamber as claimed claim 1.

12. A gas turbine engine comprising the head part of the annular combustion chamber as claimed in claim 1.

13. A method of installing a burner collar of a head part of an annular combustion chamber for a gas turbine, the head part comprising:
an end wall with a first opening for accommodating a burner;
a heat shield covering a back side of the end wall which faces towards the combustion chamber, the heat shield comprising a second opening for accommodating the burner; and
a burner collar adapted to fit within the second opening and receive a burner;
wherein the method comprises:
fastening the burner collar to the heat shield with one or more first fasteners to form a sub assembly; and
fastening the heat shield of the sub assembly to the end wall with one or more second fasteners, such that the burner and the one or more first fasteners is accommodated by the first opening.
